(19) United States
(12) Patent Application Publication
(10) Pub. No.: US 2022/0279712 A1
(43) Pub. Date: Sep. 8, 2022

(54) APPARATUS FOR LAND CLEARING AND PREPARATION HAVING INTERCHANGEABLE CHAMBER INSERTS

(71) Applicant: Fecon, LLC, Lebanon, OH (US)

(72) Inventors: Ian Alexander Gambill, South Lebanon, OH (US); Steven Keith Watson, III, West Chester, OH (US); Ryan Taylor Bricker, Dublin, OH (US); Jeffrey Stanley, Lebanon, OH (US)

(21) Appl. No.: 17/191,156

(22) Filed: Mar. 3, 2021

(51) Int. Cl. A01D 34/52; A01D 34/43; A01D 34/835

(52) U.S. Cl. CPC A01D 34/52; A01D 34/43; A01D 34/8355

(57) ABSTRACT

A land preparation apparatus includes a rotatable tool including a body and a plurality of tool assemblies disposed on an outer surface of the body. The land preparation apparatus also includes a housing including a first end, a second end, and a framework extending between the first and second ends. Ends of the rotatable tool are rotatably connected to the first and second ends. The framework has an interior surface that extends along at least a portion of the width of the rotatable tool. The interior surface has two or more interior surface sections across its width, with each of the interior surface sections defining a corresponding chamber section. The interior surface combines with a periphery of the rotatable tool, the first end, and the second end to define a chamber.

### BACKGROUND

The present disclosure relates to attachment systems and methods for land preparation tools, such as cutting, grinding, mulching, and/or shredding tools, and more particularly tool interfaces for attachments to powered vehicles.

Land preparation and clearing machines and apparatus such as forestry machines and apparatus may be utilized for vegetation management, clearing land, creating paths, and otherwise removing debris, brush, trees, vegetation, soil, concrete, asphalt, rock, and/or other materials, making the land suitable for further development or use. To carry out these tasks, such machines may be fitted with land preparation attachments or apparatus operable to mulch, cut, shred, and/or grind vegetation, brush, trees, stumps, soil, concrete, asphalt, rock, and other materials.

In particular, the machine or vehicle to which the apparatus is integrally or detachably attached may be a tractor, skid steer, or other vehicle to facilitate articulation and movement of the mowing apparatus with respect to the vegetation. Often, the vehicle may be a multi-purpose vehicle having the capability to be fitted with any of a variety of attachments suitable for the desired tasks.

### SUMMARY

According to one embodiment, a land preparation apparatus comprises a rotatable tool having a longitudinal axis. The rotatable tool comprises a body and a plurality of tool assemblies disposed on an outer surface of the body. The land preparation apparatus also comprises a housing comprising a first end at a first side, a second end at a second side, and a framework extending between and connected to each of the first end and the second end. The rotatable tool is rotatably connected to the first end and the second end. The framework has an interior surface that extends along at least a portion of the width of the rotatable tool and, along with at least a portion of a periphery of the rotatable tool, the first end, and the second end, defines a chamber. The interior surface of the chamber has an upper edge and a lower edge. The interior surface comprises two or more interior surface sections across a width of the interior surface. Each of the interior surface sections defines a corresponding chamber section.

According to another embodiment, a land preparation apparatus comprises a rotatable tool having a longitudinal axis. The rotatable tool comprises a body and a plurality of tool assemblies disposed on an outer surface of the body. The land preparation apparatus also comprises a housing comprising a first end at a first side, a second end at a second side, and a framework extending between and connected to each of the first end and the second end. The rotatable tool is rotatably connected to the first end and the second end. The framework has an interior surface that extends along at least a portion of the width of the rotatable tool and, along with at least a portion of a periphery of the rotatable tool, the first end, and the second end, defines a chamber. The interior surface of the chamber has an upper edge and a lower edge and defines one or more chamber insert receiving holes. The interior surface comprises two or more interior surface sections across a width of the interior surface. Each of the interior surface sections defines a corresponding chamber section. The land preparation apparatus further comprises one or more chamber inserts releasably attached to the interior surface. Each of the one or more chamber inserts comprises one or more threaded fasteners. The one or more threaded fasteners are received by the one or more chamber insert receiving holes, such that the one or more threaded fasteners are protected from exposure in the chamber. At least a portion of each of the one or more chamber inserts resides in the chamber.

The embodiments of the disclosure will be more fully understood in view of the following detailed description, in conjunction with the drawings.

### BRIEF DESCRIPTION OF THE DRAWINGS

The following detailed description of embodiments can be best understood when read in conjunction with the drawings enclosed herewith:

FIG. 1 is a side isometric view of a land preparation and clearing machine having an illustrative land preparation apparatus according to one or more embodiments;

FIG. 2 is a isometric view of the illustrative land preparation and clearing machine of FIG. 1;

FIG. 3 is a front elevational view of the illustrative land preparation apparatus of FIG. 1 with a view of an illustrative rotatable tool according to one or more embodiments;

FIG. 4 is a cutaway exploded view of an illustrative rotatable tool of FIG. 3 showing a coupling arrangement of a tool assembly to a rotatable tool drum according to one or more embodiments;

FIG. 5 is a cutaway exploded view of an illustrative rotatable tool of FIG. 3 showing a coupling arrangement of an illustrative wear plate and shear bar insert to an interior surface of a three-sectioned chamber according to one or more embodiments;

FIG. 6 is a side, cross-sectional view of the illustrative land preparation apparatus of FIG. 1, in a first position, showing the illustrative wear plate and shear bar insert of FIG. 5;

FIG. 7 is a side, cross-sectional view of the illustrative land preparation apparatus of FIG. 1, in a second position, showing the illustrative wear plate and shear bar of FIG. 5;

FIG. 8 is an isometric, cross-sectional view of the illustrative land preparation apparatus of FIG. 3 showing the illustrative wear plate and shear bar insert of FIG. 5;

FIG. 9 is a rear isometric view of the illustrative wear plate of FIG. 5;

FIG. 10 is a side view of the illustrative wear plate of FIG. 5;

FIG. 11 is a front isometric view of the illustrative shear bar insert of FIG. 5;

FIG. 12 is a rear view of the illustrative shear bar insert of FIG. 5;

FIG. 13 is a side view of the illustrative shear bar insert of FIG. 5;

FIG. 14 is a side, cross-sectional view of the illustrative land preparation apparatus according to another embodiment and showing an illustrative rake insert according to one or more embodiments; and

FIG. 15 is a top, front isometric view of the illustrative rake insert of FIG. 14;

FIG. 16 is a rear view of the illustrative rake insert of FIG. 14;

FIG. 17 is a side view of the illustrative rake insert of FIG. 14; and

FIG. 18 is a front elevational view of the illustrative land preparation apparatus according to another embodiment, but without the rotatable tool, to show an interior surface of a three-sectioned chamber having an alternative chamber insert configuration.

The embodiments set forth in the drawings are illustrative in nature and not intended to be limiting of the invention defined by the claims. Moreover, individual features of the drawings and the disclosure will be more fully apparent and understood in view of the detailed description.

### DETAILED DESCRIPTION

The present disclosure is generally directed to vegetation management and land preparation and clearing machines (“land preparation machines”) and their corresponding implements that are generally designed to cut, grind, mulch, shred, clear, mill, and/or mix trees, brush, ground cover, vegetation, debris, asphalt, concrete, and/or soil. The land preparation machines and their corresponding implements may comprise a variety of vehicles and implements, including but not limited to skid steer vehicles, forestry machines and vehicles, PTO tractors, farm tractors, and/or any other known vehicles and their corresponding implements compatible with land preparation and clearing. Such land preparation machines may prepare the surface and subsurface of the earth. As used herein, the phrases “land preparation and clearing” and “land preparation” will mean any land preparation and clearing operations, including but not limited to forestry operations such as cutting, grinding, mulching, shredding, clearing, milling, and/or mixing trees, brush, ground cover, vegetation, debris, soil, rock, asphalt, concrete, and/or soil. As used herein, “feed material” describes trees, brush, ground cover, vegetation, debris, soil, rock, asphalt, concrete, and/or soil produced from such land preparation and clearing operations, including but not limited to forestry operations such as clearing land, cutting and/or mulching trees, and/or preparing land surfaces (e.g., creating paths).

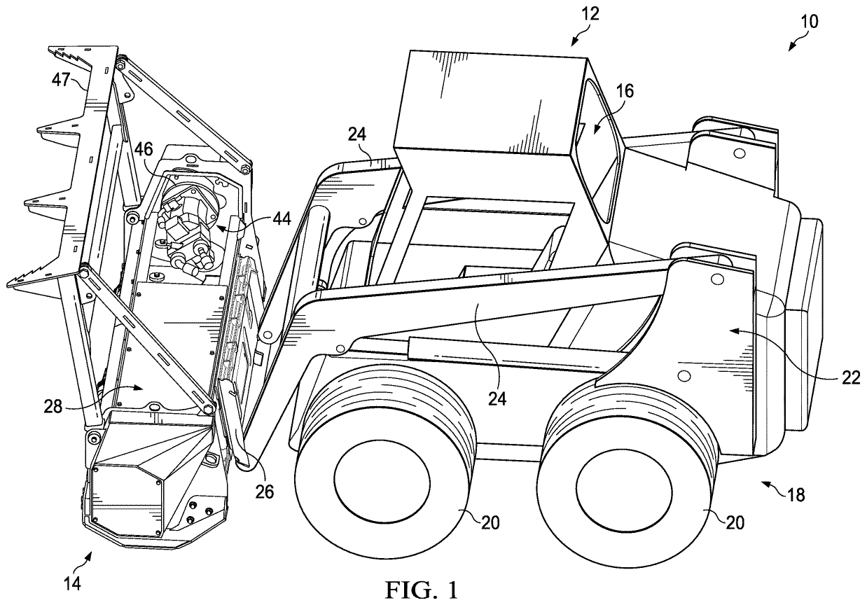

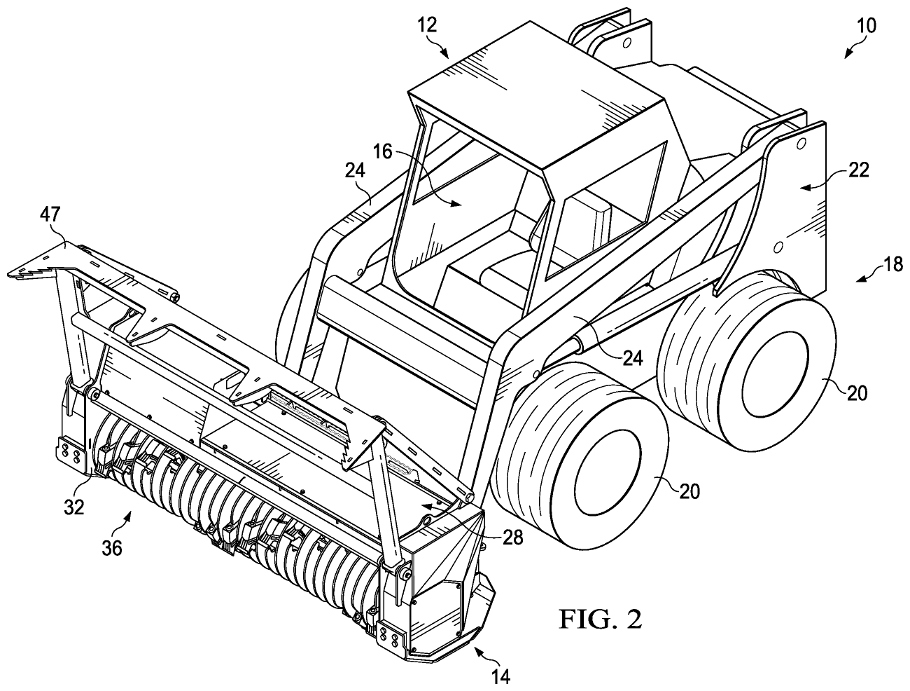

Referring to FIGS. 1-2, an illustrative embodiment of a land preparation machine 10 includes a vehicle 12 (e.g., a forestry vehicle) and a land preparation apparatus 14 connected to the vehicle 12. In this illustrative embodiment, the vehicle 12 is a skid steer vehicle suitable for off-road travel, and includes a driver station 16 as well as an all-terrain wheel assembly 18. The wheel assembly 18 may include tires 20. In addition, tires 20 may drive all-terrain tracks (not shown), which may provide traction for the vehicle 12 to move over a variety of terrains and in a variety of conditions. The all-terrain tracks may comprise metal or rubber-based tracks that wrap around tires 20 as known to one of ordinary skill in the art. In some embodiments, vehicle 12 may not include tires 20, but have a track drive system that includes only tracks that are driven by track drive wheels or sprockets. The vehicle 12 may also include a hydraulically operated vertical lift assembly 22 for vertically lifting the land preparation apparatus 14, and any other attachments that may be used with the vehicle. Vertical lift assembly 22 may include one or more lift arms 24. Controls (not shown) can be provided for control of the hydraulic lift assembly 22, including the lift arms 24 as well as for controlling the power provided to the wheel assembly 18 and for controlling the operation of the land preparation apparatus 14.

While the land preparation apparatus 14 is shown in this example connected to and powered by vehicle 12, which is a skid steer vehicle, other suitable all-terrain vehicles with capability for powering and utilizing a hydraulic motor attachment or tool (e.g., such as land preparation apparatus 14) could be provided, such as other forestry vehicles, mini-track loaders, excavators, backhoes, PTO tractors, farm tractors, and/or any other known vehicles and their corresponding implements compatible with land preparation and clearing. Further examples of suitable skid steer vehicles are shown and described in U.S. Pat. Nos. 4,168,757 and 4,209,071, the entire disclosures of which are hereby incorporated by reference herein. In some embodiments, such vehicles 12 may include remote controlled vehicles.

In the illustrative embodiment shown in FIGS. 1 and 2, the land preparation apparatus 14 is removably connectable to the vehicle 12. The connection between the land preparation apparatus 14 (or any other attachment) and the vehicle 12 can be accomplished in any of a variety of manners. For example, receptacles, such as flanges 26, may be provided on a rear portion of the land preparation apparatus 14 to facilitate a connection with vertical lift arms 24 from the vehicle 12. In particular, such flanges and/or other rear portions of the land preparation apparatus 14 may define one or more bolt holes for receiving connector bolts (not shown). In certain embodiments, the land preparation apparatus 14 may include a hydraulic supply connection for receiving an operating supply of hydraulic fluid from a pump within the vehicle to power the land preparation apparatus 14, and a hydraulic return connection for returning hydraulic fluid to a tank within the vehicle 12. The hydraulic supply and return connections may comprise conventional quick-disconnect connections as known to one of ordinary skill in the art. In such embodiments, a hydraulic cooler may be provided to maintain the supply of hydraulic fluid at a desired temperature and viscosity. In such embodiments, the hydraulic cooler may be mounted to the vehicle 12.

It is understood that, in certain embodiments, the land preparation apparatus 14 may be fixedly attached to the vehicle 12. However, it will be appreciated that in certain embodiments, a land preparation apparatus may be a stand-alone machine, such as a walk-behind land preparation apparatus. Also, it is understood that other hydraulically-operated rotary mowing or cutting attachments may be utilized with principles of one or more of the embodiments shown and described herein, integral with or detachable from vehicle 12, and/or separately from or in combination with the land preparation apparatus 14. Other configurations are also possible, such as, for example, where the fluid pump and tank are located at other locations. Connection, powering, and movement of the land preparation apparatus 14 can be accomplished with various configurations, such as those described in U.S. Pat. Nos. 4,148,366, and 5,813,792, for example, which are hereby incorporated herein by reference.

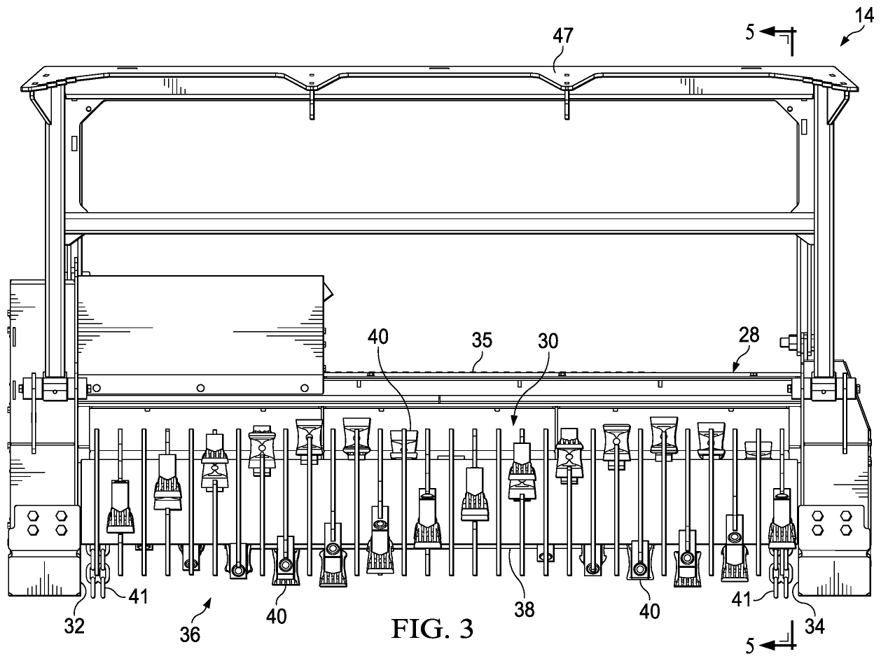

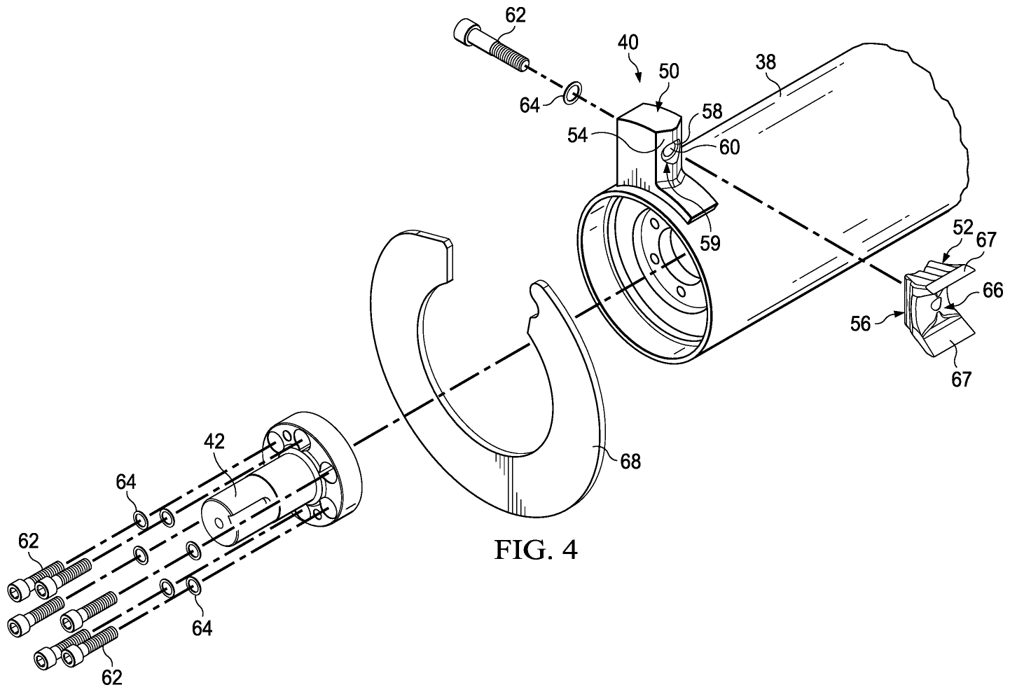

Referring to FIGS. 1-4, for example, the land preparation apparatus 14 may include a housing 28 having a first end and a second end. In certain embodiments, the first and second ends may be right and left end caps 32, 34, respectively, but it will be appreciated that other types of first and second ends may be provided. The housing 28 may further include a framework 35, and as shown in FIG. 3, the framework may extend between and be connected to each of the first end cap 32 and the second end cap 32. The land preparation apparatus 14 may further include a movable tool (e.g., rotatable tool 36) movably (e.g., rotatably) connected to and between the right and left end caps 32, 34 within a chamber 30. In some embodiments, for example, in FIG. 3, right and left end caps 32, 34 may be integral with the housing 28. As shown in FIGS. 2 and 3, the rotatable tool 36 can define a longitudinal axis and may comprise a body. As shown, for example, in FIGS. 3 and 4, the body may be a rotatable tool drum 38. However, it will be appreciated that other suitable types of bodies may be provided, including non-cylindrical bodies. The rotatable tool may further comprise a plurality of tool assemblies 40, which may be disposed on an outer surface of the body (e.g., rotatable tool drum 38). In particular, the plurality of tool assemblies 40 can be spaced along and extend radially from the tool drum 38. For additional details regarding the arrangement of tool assemblies 40 on the rotatable tool drum 38, U.S. Publication No. 2009/0050341 A1 has been incorporated by reference herein in its entirety. The housing 28 may further comprise a plurality of chains 41 held in place by a chain rod (not shown) extending substantially across the width of the housing 28 from the right end cap 32 to left end cap 34, where the chain rod may be retained without welding or tapping.

In certain embodiments, rotatable tool 36 may also comprise an axle 42 extending longitudinally from either one or both ends of the tool drum 38. As shown in FIG. 4, for example, the axle 42 may be connected to the rotatable tool drum 38 by a plurality of securing bolts 62. A locking washer 64, locking pin, or other suitable mechanism may be used along with each of the one or more securing bolts 62 to ensure the firm securement of the axle 42 to the tool drum 38. For movement of the rotatable tool 36, a hydraulic motor 44, such as a hydraulic piston motor, provides rotation of a rotor (e.g., drive shaft 46) which drives the rotatable tool drum 38, which thereby causes rapid rotation of the plurality of tool assemblies 40, such as at speeds of between about 100 to about 3000 rpm. The drive shaft 46 may drive a belt (not shown), which engages and drives the axle 42 to turn tool drum 38. Alternatively, the drive shaft 46 may be directly connected to the drum 38 or axle 42.

In one embodiment, the hydraulic lift arms 24 can raise and lower the land preparation apparatus 14 via the controls to allow the plurality of tool assemblies 40 (e.g., the teeth or cutters of the tool assemblies 40) to come into contact with brush, trees, vegetation, or other objects to be cut or shredded or cleared. The controls may also control the supply of fluid to the hydraulic motor 44 to start and stop the rotation of the tool drum 38 and tool assemblies 40. The land preparation apparatus 14 may include any number of suitable components, cutters, grinders, mixers, and/or tools for providing a cutting, grinding, mulching, shredding, clearing, milling, and/or mixing function.

In addition, the land preparation apparatus 14 may comprise one or more safety mechanisms, such as a guard assembly 47, which is shown, for example, in FIGS. 1-3, extending substantially upwardly from the framework 35 of the housing 28. In certain embodiments, the guard assembly 47 may include a gauge (not shown). In some embodiments, the gauge may facilitate visual measurements for widths of, for example, trees and other vegetation. For example, in one embodiment, a center of the gauge may have a zero reading and distance markings may be provided in both directions extending laterally therefrom, where the values of such distance markings increase as the distance from the center of the gauge increases. By aligning, for example, trees or other vegetation with the center, a driver or operator of the land preparation machine 10 may be able to make a quick size estimation to facilitate a determination of whether to clear such trees or other vegetation. The gauge can be applied to the guard assembly 47 by any suitable manner, such as printing distance markings thereon or attaching a separately formed gauge thereto, such that the gauge can be viewable by the driver or operator of the land preparation machine 10.

In other embodiments, the hydraulic motor 44 may be controlled by a hydraulic brake (not shown) that can automatically slow the motor 44 when the flow of hydraulic fluid to the motor via the hydraulic supply line is discontinued. For additional detail on land preparation machinery (e.g., forestry machinery) or hydraulic components associated with land preparation machinery (e.g., forestry machinery), U.S. Publication No. 2006/0032222 has been incorporated by reference in its entirety herein.

Referring to the embodiment shown in FIG. 4, each of the plurality of tool assemblies 40 comprises a tool holder 50 and a land preparation tool 52. Suitable examples of land preparation tools 52 can include, but are not limited to, one or more of a cutter, blade, grinder, chipper, tooth, knife, hammer tool, milling tool, flailing tool or element, carbide tip, steel tip, composite tip, and any other tool for suitable for land surface preparation and clearing as described and defined above herein. Any of the plurality of tool assemblies 40, and any of their respective components, may be fabricated from a variety of metals, composites, plastics, or combinations thereof. Additional detail regarding tool assemblies is provided in U.S. Pat. Nos. 4,223,441 and 4,222,418, which are hereby incorporated by reference herein. Further, as will be described herein in view of the figures, the tool holder 50 can be a support structure for the land preparation tool 52. In certain embodiments, and as shown in FIG. 4, the land preparation tool 52 may be directly connected to the tool holder 50. In other embodiments, however, a land preparation tool may be connected to a tool holder via an intermediate connector (not shown). As used herein, “connected” may mean fixedly connected (e.g., by welding together the tool holder 50, the land preparation tool 52, and optionally an intermediate connector) or removably connected (e.g., by bolting, matingly coupling, adhering, or magnetically coupling the tool holder 50, the land preparation tool 52, and optionally an intermediate connector). If removable, the land preparation tool 52 may comprise a replaceable tip that is designed to be replaced once worn due to use, thereby permitting the tool holder 50 to remain affixed to the tool drum 38 while the land preparation tool 52 is replaced.

In certain embodiments, the tool holder 50 may include a mounting surface 54 defining a non-planar profile. As used herein, “non-planar profile” may refer to any surface which is not a straight planar surface (e.g., V-shaped, concave, convex, or combinations thereof). For example, and as shown in the embodiment of FIG. 4, the non-planar profile of the mounting surface 54 of the tool holder 50 may define a convex V-shape. Additionally, each land preparation tool 52 may also comprise a mounting surface 56 defining a non-planar profile that is the inverse of the profile of the tool holder mounting surface 54. For example, and as shown in the embodiment of FIG. 4, the mounting surface 56 of the land preparation tool 52 may define a concave V-shape, which is the inverse of the convex V-shape configuration of the tool holder mounting surface 54. This interaction may yield an interference fit or a friction fit between the inverse surfaces 54 and 56 that can combat sliding (e.g., horizontal sliding) of the tool holder 50 or land preparation tool 52. While the above-described embodiment is depicted in FIG. 4, it will be appreciated that other suitable configurations may be provided for the respective mounting surfaces 54 and 56.

Moreover, in certain embodiments, other coupling arrangements may be provided in addition to or in place of the interference fit between inverse mounting surfaces. Such coupling mechanisms may include, but are not limited to, at least one opening disposed on and/or at least one bushing or peg extending from one mounting surface (e.g., 54 or 56) to a corresponding mating arrangement (e.g., recess) on the opposing mounting surface. For example, and as shown in FIG. 4, the tool holder mounting surface 54 can include a recess 58 defining a first opening 59 disposed at one end of a channel 60, wherein the channel 60 includes internal threading and extends through the tool holder 50 to a second opening (not shown) disposed on an opposite end of the tool holder 50. In order to further ensure that the tool holder 50 and the land preparation tool 52 are secured to each other, an as shown in FIG. 4, the rotatable tool 36 may utilize one or more securing bolts 62, which can include external threading to engage, for example, the internal threading of the channel 60. Thus, the one or more securing bolts 62 can extend through the channel 60 of the tool holder 50 and a portion of the land preparation tool 52, the mounting surface 56 of which may further include an opening (not shown) to a threaded channel (not shown), such that the respective channels (e.g., 60) of the tool holder 50 and land preparation tool 52 are aligned. A locking washer 64, locking pin, or other suitable mechanism may be used along with each of the one or more securing bolts 62, as shown in FIG. 4, to ensure the firm securement of the same within the channels of the tool holder 50 and land preparation tool 52.

The inverse mounting surfaces 54 and 56 of the tool holder 50 and land preparation tool 52, respectively, can yield many unique advantages to the land preparation machine 10. For example, the V-shaped non-planar profiles of inverse mounting surfaces 54 and 56 can provide a locking advantage by ensuring that all forces are driven to a center of the tool holder 50. This increased contact area, along with the V-shaped profile, can reduce the opportunity for the bolting system to loosen during vibration and shock loading. The vertical direction of the V-shaped profile can allow for symmetrical tools that can be flipped to utilize a double-ended tool design. The locking advantage provided by the V-shaped design can greatly reduce the risk of the tool rotating or twisting the mounting joint with impact compared to alternative designs. The V-shaped tool profile can allow for lower cost manufacturing. Moreover, the increased surface area, along with the V-shaped profile, can allow for manufacturing variations as well as the performance benefits provided by the larger supporting surface area. For additional details regarding the bolt securing mechanism, U.S. Publication No. 2009/0014189 A1 is incorporated by reference herein in its entirety. Furthermore, it will be appreciated that other coupling mechanisms for a tool holder and land preparation tool are contemplated herein, such as, for example, welding, adhering, magnetically coupling, or combinations thereof.

In certain embodiments, and as shown in FIG. 4, the land preparation tool 60 can further include a cutting surface 66 comprising at least one blade or any other tooling component described above. In one embodiment, the cutting surface 66 may comprise twin side-by side blades. In another embodiment, the cutting surface 66 can include a circular blade. Alternatively, and as shown, for example, in FIG. 4, the cutting surface 66 may be U-shaped and include two cutting blades 67 disposed on opposite sides or ends thereof. Such cutting blades 67 can be relatively sharp edges at respective extremities of the U-shaped cutting surface 66, disposed distally and generally parallel to each other and/or an imaginary plane bisecting the same. The cutting blades 67 can be tapered distal edges of the cutting surface, and the tapered distal edges of cutting blades 67 can be tapered to a blade-like edge. It will be appreciated that a concave profile of a cutting surface may be a V-shaped outwardly extending profile, a convex profile, a non-planar profile, a trapezoidal profile, or another suitable profile familiar to one of ordinary skill in the art. For additional details regarding the plurality of tool assemblies 40, including various configurations of the tool holders 50, land preparation tools 52, connections therebetween, and cutting surfaces 66 thereon, each of U.S. Publication Nos. 2019/0335673 and 2019/0335648 has been incorporated by reference herein in its entirety.

Referring again to the embodiment of FIG. 4, the rotatable tool 36 may further comprise a plurality of depth control rings 68 that may be attached to and extend from the rotatable tool drum 38. In such embodiments, an inner diameter of the depth control ring 68 may be disposed about an outer surface of the rotatable tool drum 38. In certain embodiments, the depth control ring 68 can be fixedly coupled (e.g., welded, epoxied, screwed, bolted, braised, bonded, etc.) to the outer surface of the rotatable tool drum 38. In other embodiments, the depth control rings 68 may be detachably coupled to the outer surface of the rotatable tool drum 38 through conventional and/or yet-to-be developed mechanisms. In some embodiments, the tool holder 50 of each tool assembly 40 may be coupled to the depth control ring 68. In any case, the depth control ring 68 can extend radially from the outer surface of the rotatable tool drum 38. The extent to which to the depth control ring 68 can extend therefrom, or a depth height, may be varied to provide a desired distance between a maximum radial dimension of the land preparation tool 52 of the tool assembly 40 and a peripheral edge of the depth control ring 68 and/or the outer surface of the rotatable tool drum 38. In certain embodiments, the depth height of the depth control ring 68 can be less than the overall height of the tool assembly 40. For example, in some embodiments, the depth height of the depth control ring 68 may be less than or equal to half of the overall height of the tool assembly 40 when installed. In certain embodiments, the depth height of the depth control ring 68 can be about 20% to about 80% of the overall height of the tool assembly 40 when installed. In certain embodiments, the depth height of the depth control ring 68 can be about 30% to about 60% of the overall height of the tool assembly 40 when installed. It will be appreciated, however, that a depth height of a depth control ring can be less than, greater than, or equal to any other partial height of a tool assembly when installed. For additional details regarding the depth control rings (e.g., 68) on a rotatable tool drum (e.g., 38), U.S. Publication No. 2017/0079219 A1 has been incorporated by reference herein in its entirety.

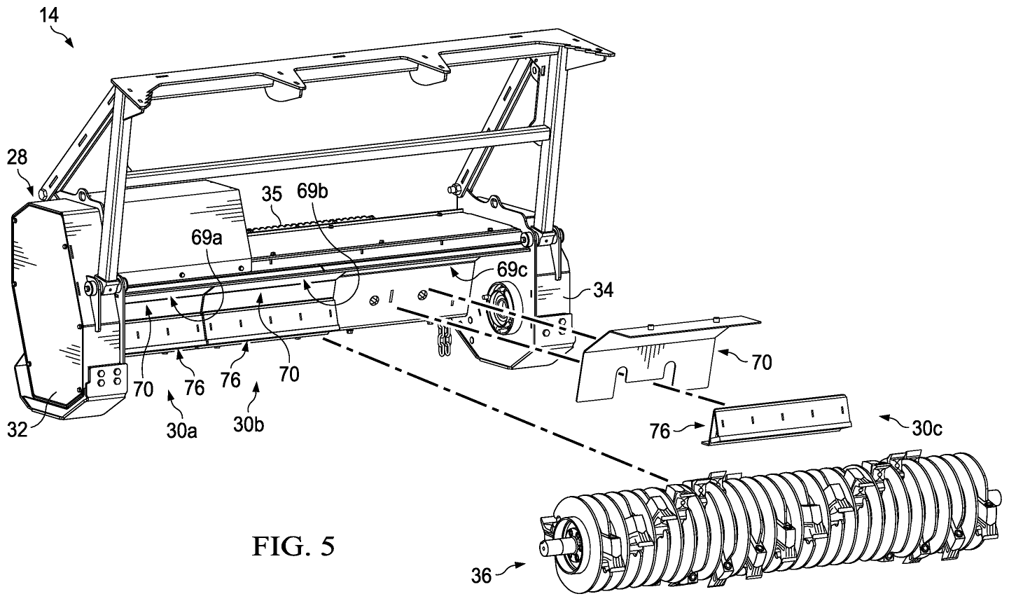

Referring to FIG. 5, the framework 35 of the housing 28 can include an interior surface 69 that can extend along at least a portion of the width of the rotatable tool 36. The interior surface 69 can combine with at least a portion of a periphery of the rotatable tool 36, the right end cap 32, and the left end cap 34 to define the chamber 30, in which at least a portion of the cutting, grinding, mulching, and shredding of trees and other vegetation by the land preparation apparatus 14 may occur. In certain embodiments, the interior surface 69 can comprise multiple sections across its width. Each of such interior surface sections can define a corresponding chamber section. For example, and as shown in FIG. 5, the interior surface 69 can comprise three distinct interior surface sections 69a, 69b, and 69c, which can define chamber sections 30a, 30b, and 30c. In some embodiments, the interior surface sections (e.g., 69a, 69b, and 69c) may be defined by the interior surface 69 or by one or more chamber inserts (e.g., wear plate 70) attached thereto. While FIG. 5 depicts a three-sectioned chamber 30, it will be appreciated that, in other embodiments, a chamber may include a singular section, two section, or four or more sections.

The ability of the land preparation apparatus 14 to perform such tasks and others may depend upon, among other things, sizing of materials fed into and received by the chamber 30, a rate at which such materials can be fed, and whether the land preparation apparatus is moving in a forward or reverse direction. In certain embodiments, the land preparation apparatus 14 may include one or more chamber inserts (e.g., 70) to, for example, facilitate regulation of such aspects, among others. In certain embodiments, the one or more chamber inserts (e.g., 70) may be releasably attached to the interior surface 69, such that at least a portion of the one or more chamber inserts may reside in the chamber 30. Accordingly, the one or more chamber inserts may be configured or constructed to adapt to the interior surface 69 of the chamber 30. In certain embodiments where more than one chamber insert is utilized, each of the chamber inserts (e.g., 70) may be releasably attached to separate interior surface sections 69a, 69b, and 69c, such that each chamber insert can be positioned within a different chamber section 30a, 30b, and 30c. In use, the one or more chamber inserts (e.g., 70) may allow greater flexibility for the ability of the land preparation apparatus 14 to efficiently and effectively manage a wide range of vegetation and clear different types of land, among other tasks.

In certain embodiments, the chamber 30 can span, length-wise or height-wise, from an intake opening defined by a first imaginary plane to a discharge opening defined by a second imaginary plane. The first imaginary plane can be substantially parallel to the ground and can intersect both a lower perimeter of the chamber 30 and the periphery of the rotatable tool 36. The lower perimeter of the chamber 30 can be defined by a lower of a lowest point of the one or more chamber inserts, if attached, and a lower edge 72 of the interior surface 69. Accordingly, the lower perimeter may vary by chamber section (e.g., 30a, 30b, and 30c) as different chamber sections may have different chamber inserts or no chamber inserts attached thereto. The second imaginary plane can be substantially perpendicular to the ground and can intersect both an upper edge 71 of the interior surface 69 and the periphery of the rotatable tool 36.

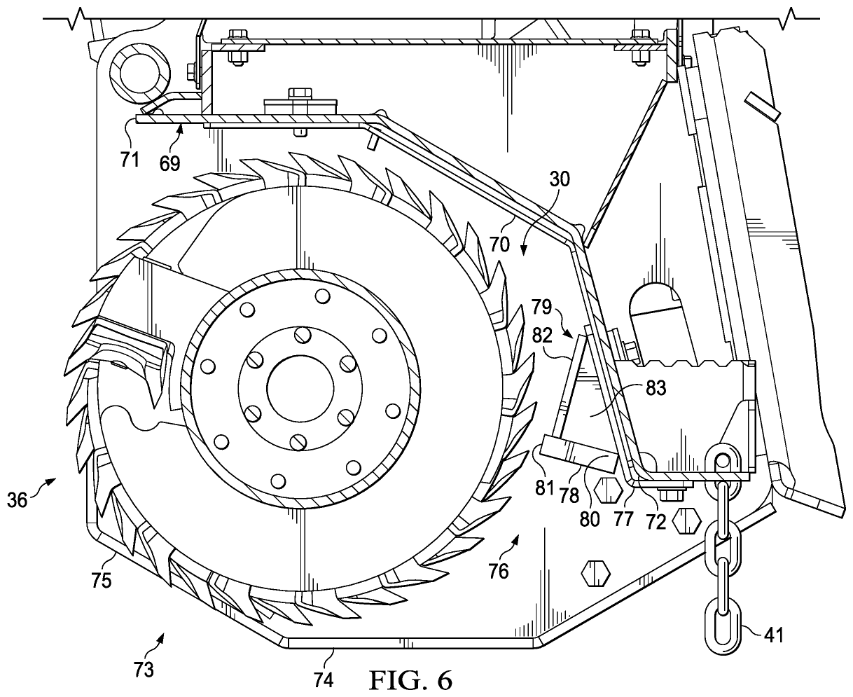

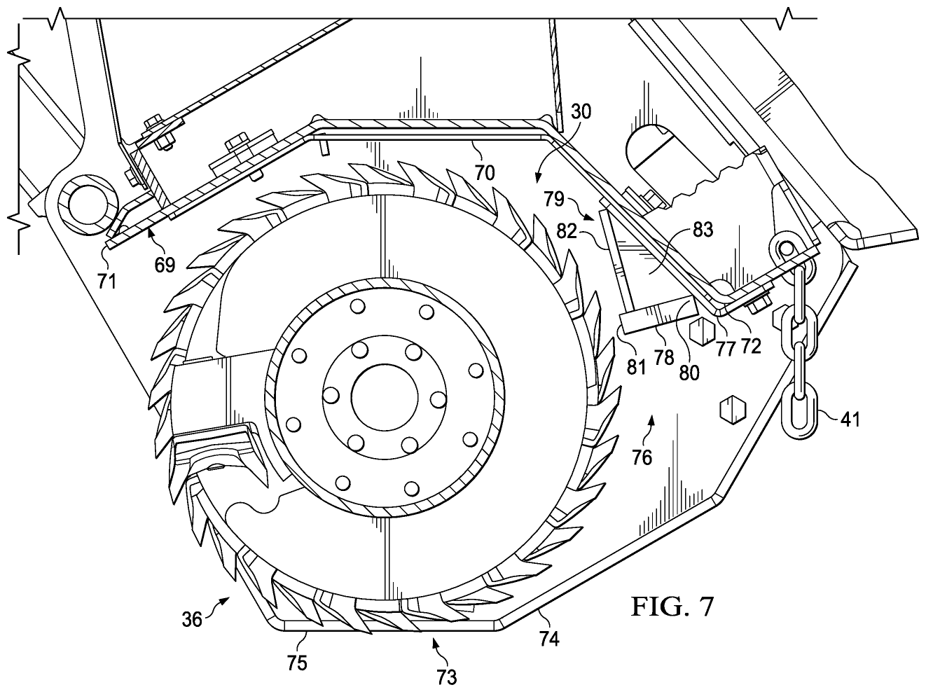

In certain embodiments, the land preparation apparatus 14 may be operable in each of a first position and a second position. For example, in such embodiments, the land preparation apparatus 14 may be configured for standard, forward movement in the first position, as shown in FIG. 6, and for back-dragging, reverse movement in the second position, as shown in FIG. 7, in order to allow for greater efficiency in operation. It will be appreciated that a height employed for the lower chamber perimeter can affect the amount of material that can be fed into a chamber. For example, a lower chamber perimeter height that is too tall may result in overfeeding a chamber and overwhelming a rotatable tool, while a lower chamber perimeter height that is too short may result in lower processing times and other inefficiencies due to an inability to feed material as quickly. In certain embodiments, whether the land preparation is in the first position or the second position may be indicated by positioning of skid shoes 73 at the bottom of each of the right and left end caps 32, 34 as illustrated, for example, by FIGS. 6 and 7. For example, each of the skid shoes 73 can comprise a first planar surface 74 and a second planar surface 75, where the first planar surface 74 can be substantially parallel with a ground surface in the first position, as shown in FIG. 6, and the second planar surface 75 can be substantially parallel with a ground surface in the second position, as shown in FIG. 7.

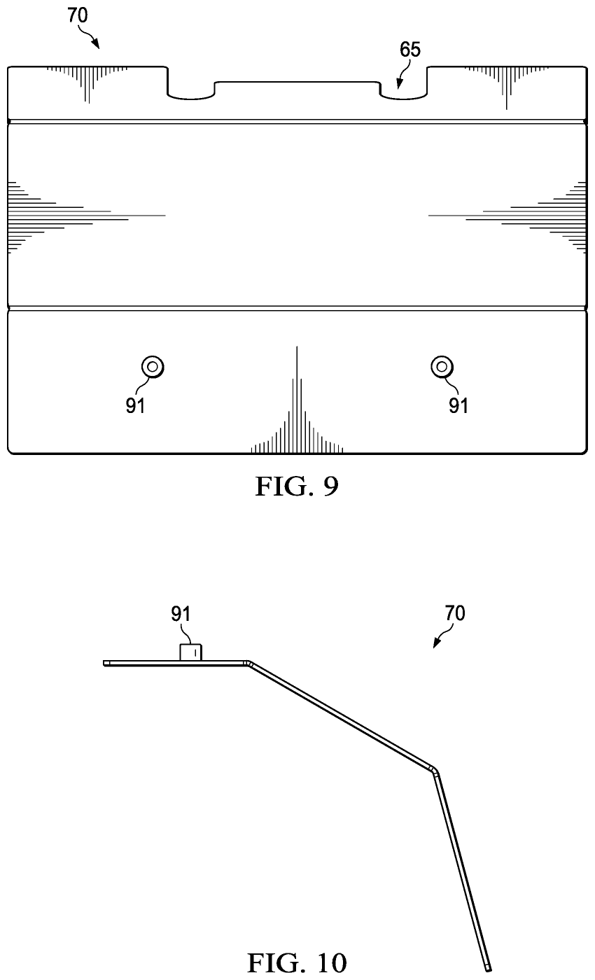

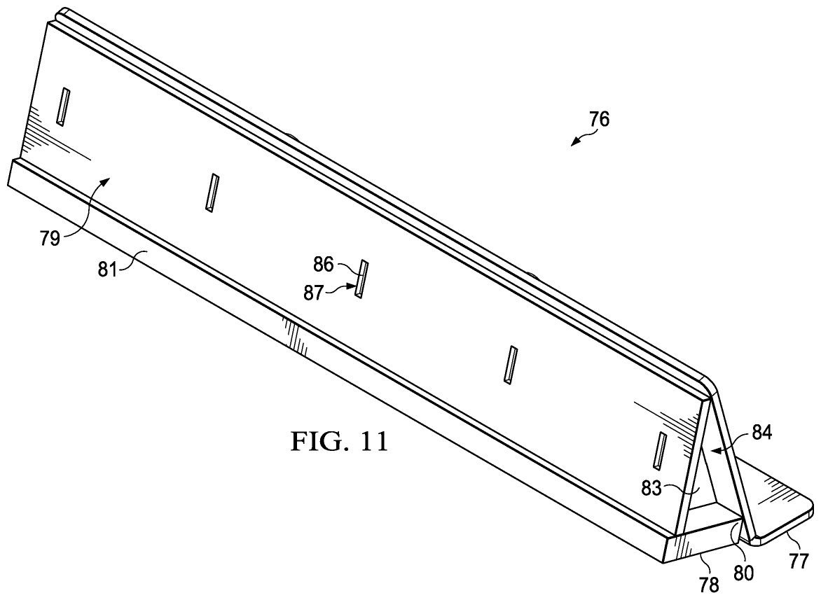

In certain embodiments, the one or more chamber inserts can include a wear plate 70, as shown, for example, in FIGS. 5-10. The wear plate 70 can be releasably attached to the interior surface 69 of the housing 28 by any of a variety of suitable connections. The wear plate 70 may extend along at least a portion of a width of the interior surface 69. For example, in certain embodiments, the wear plate 70 may extend along, or may help to define, a width of one of the interior surface sections 69a, 69b, and 69c. As shown in FIG. 6, for example, the wear plate 70 also may extend from near the upper edge 71 of the interior surface 69 to the lower edge 72, and an inner surface of the wear plate 70 can be in direct contact with the interior surface 69. In certain embodiments, the wear plate 70 may be shaped to for use with other chamber inserts (e.g., 76). For example, and as shown in FIG. 9, the wear plate 70 may further comprise slots 65 or cutouts to accommodate a connection between other chamber inserts (e.g., 76). In such embodiments, one end of the wear plate 70 may be attached to the interior surface 69 near the upper edge 71 while the other end may be secured to the interior surface 69 by the connection between other chamber inserts (e.g., 76) and the interior surface 69. In such embodiments, a base wear plate (not shown) may facilitate securement of the wear plate 70 to the interior surface 69. The base wear plate may be substantially flat.

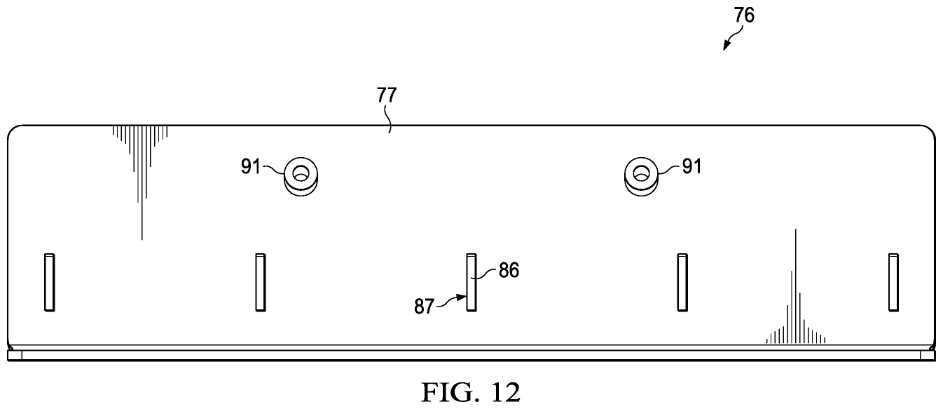

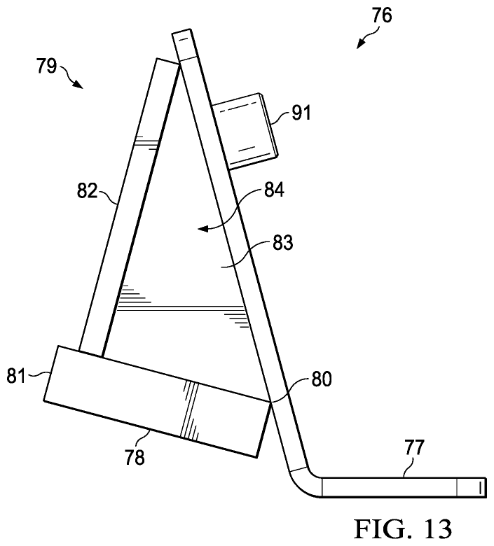

In certain embodiments, the one or more chamber inserts can include a shear bar insert 76, as shown, for example, in FIGS. 5-8 and 11-13. The shear bar insert 76 can include a shear bar base plate 77, a shear bar 78, and a support assembly 79. In certain embodiments, the shear bar base plate 77 can be releasably attached, directly or indirectly, to the interior surface 69 by any of a variety of suitable connections. As shown in FIGS. 5-8, for example, the shear bar base plate 77 can be attached to the wear plate 70, which is shown to be in direct contact with the interior surface 69. In such embodiments, the shear bar insert 76 may facilitate securement of the wear plate 70 to the interior surface 69. In other embodiments, however, the shear bar base plate 77 can be attached directly to the interior surface 69, with or without a wear plate 70 attached. Like the wear plate 70, the shear bar insert 76, may extend along at least a portion of the width of the interior surface 69. For example, in certain embodiments, the shear bar insert 76 may extend along, or may help to define, a width of one of the interior surface sections 69a, 69b, and 69c. Thus, in certain embodiments, the shear bar insert 76, including one or more of the shear bar base plate 77, the shear bar 78, and at least some portions of the support assembly 79, can have substantially the same width as one of the interior surface sections 69a, 69b, and 69c and/or the wear plate 70. In certain embodiments, and as shown in FIG. 6, for example, the shear bar base plate 77 can cover at least a portion of the lower edge 72 of the interior surface 69 of the housing 28.

As shown in FIGS. 6-8, a first edge 80 of the shear bar 78 can abut an outer surface of the shear bar base plate 77 substantially adjacent to the lower edge 72 of the interior surface 69. In such embodiments, and as shown in FIG. 5, for example, a second edge 81 of the shear bar 78 can extend into the chamber 30 to narrow the intake opening to the chamber 30, and thereby facilitate regulation of, among other things, the sizing of materials fed into and received by the chamber 30, as well as a rate at which such materials can be fed. In certain embodiments, the shear bar 78 can be angled toward the chamber 30 to promote and facilitate cutting, grinding, mulching, and shredding of trees and other vegetation. With respect to the lower perimeter of the chamber 30 when a shear bar insert 76 is attached to the interior surface 69 of the housing 28, the lower edge 72 of the interior surface may define the lower chamber perimeter when the land preparation apparatus 14 is in the first position, as shown in FIG. 5. However, when the land preparation apparatus 14 is in the second position, as shown in FIG. 6, the second edge 81 of the shear bar 78 may be lower than the lower edge 72, and thus, may define the lower chamber perimeter.

In certain embodiments, the support assembly 79 can connect the shear bar 78 and the shear bar base plate 77. In certain embodiments, the support assembly may facilitate maintaining positioning of the shear bar 78 relative to the shear bar base plate 79. For example, and as shown in FIGS. 6-8 and 11-13, the support assembly 79 can comprise a support plate 82 and one or more triangular-shaped supports 83. In some embodiments, an upper end of the support plate 82 can abut the outer surface of the shear bar base plate 77 and a lower end of the support plate 82 can abut the shear bar 78. For example, the support plate 82 can abut the shear bar 78 substantially adjacent to the second edge 81 thereof. And as shown in FIG. 6, the support plate 82, the shear bar 78, and the shear bar base plate 77 can define a channel 84. The one or more triangular-shaped supports 83 can reside in the channel 84 to provide support to at least the support plate 82, and in certain embodiments, the one or more triangular-shaped supports 83 can engage two or more of the support plate 82, the shear bar 78, and the shear bar base plate 77. As in the embodiment shown in FIG. 6, for example, the one or more triangular-shaped supports 83 engage each of the support plate 82, the shear bar 78, and the shear bar base plate 77, substantially in conformity with the triangular-shaped cross-section of the channel 84. It will be appreciated, however, that in other embodiments, the support assembly may assist in forming a channel that has a cross-section that is a different shape, or may not form a channel at all, while supports may likewise be provided in a variety of other suitable shapes. In certain embodiments, each of the one or more triangular-shaped supports 83 can further comprise one or more projections 86 and one, two, or each of the support plate 82, the shear bar 78, and the shear bar base plate 77 can further comprise one or more slots 87 to receive such projections 86. For example, in one embodiment, such as that shown in FIGS. 6-8 and 11-13, each of the support plate 82 and the shear bar base plate can comprise a plurality of slots 87 configured to receive a plurality of first and second projections 87, respectively, from the one or more triangular-shaped supports 83.

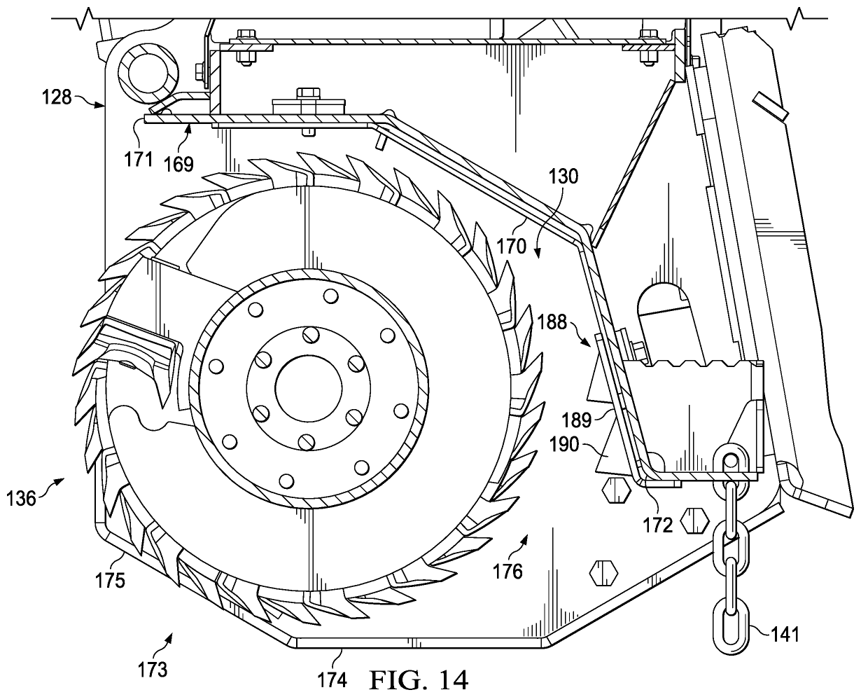

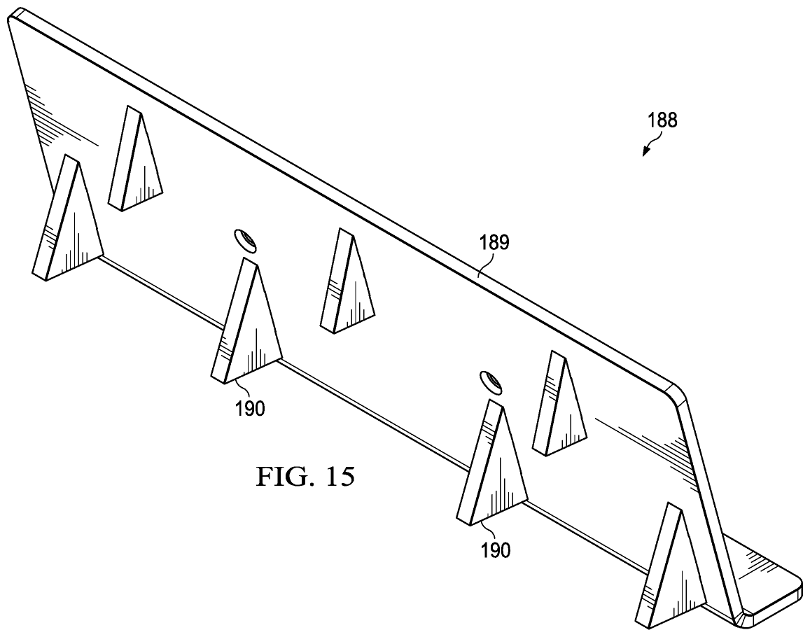

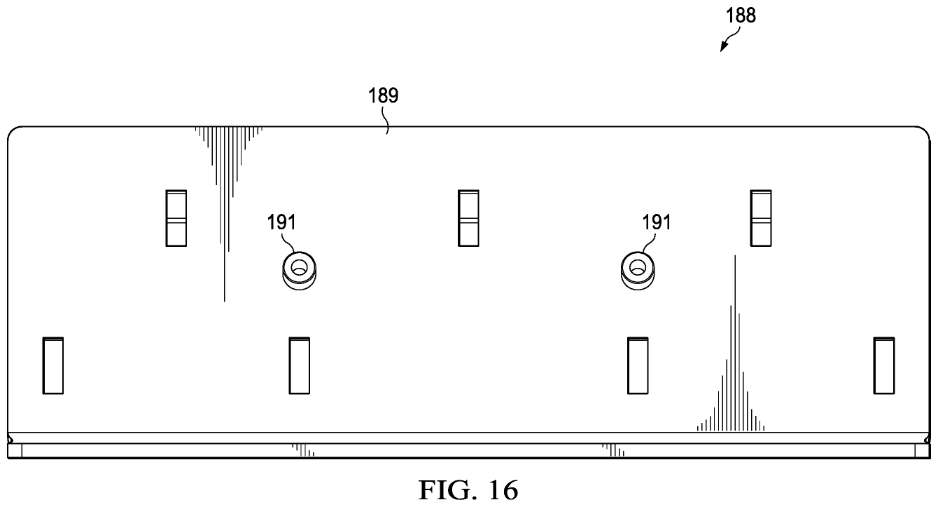

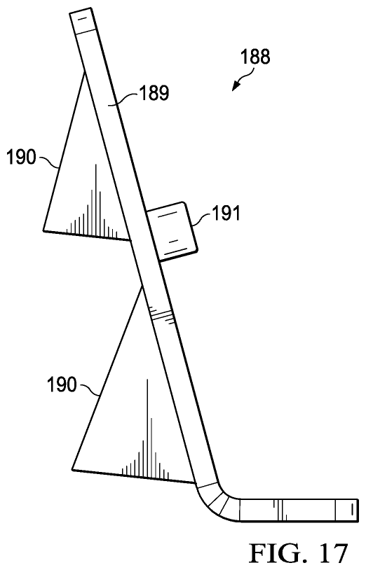

In certain embodiments, the one or more chamber inserts can include a rake insert 188, as shown, for example, in FIGS. 14-17. The rake insert 188 can comprise a rake base plate 189 and a plurality of rake tines 190. In certain embodiments, the rake base plate 189 can be releasably attached to the interior surface 169 of the housing 128. In certain embodiments, the rake base plate 189 can be releasably attached, directly or indirectly, to the interior surface 169. In such embodiments, the rake insert 188 may facilitate securement of the wear plate 170 to the interior surface 169. As shown in FIG. 14, for example, the rake base plate 189 can be attached to the wear plate 170, which is shown to be in direct contact with the interior surface 169. In other embodiments, however, the rake base plate 189 can be attached directly to the interior surface 169, with or without a wear plate 170 attached. Like the wear plate 170, the rake insert 188, may extend along at least a portion of the width of the interior surface 169. Like the shear bar insert 76, it will be appreciated that in certain embodiments, a rake insert may extend along, or may help to define, a width of an interior surface section, such that in certain embodiments, the rake insert, including a rake base plate, can have substantially the same width as an interior surface section and/or a wear plate. In certain embodiments, and as shown in FIG. 14, for example, the rake base plate 189 can cover at least a portion of the lower edge 172 of the interior surface 169 of the housing 128. The plurality of rake tines 190 can be connected to the rake base plate 189, by any suitable means, and extend from an outer surface thereof. The plurality of rake tines 190 can be positioned in any suitable configuration to facilitate efficient and effective cutting, grinding, mulching, and shredding of trees and other vegetation.

A depth of the chamber 30 may be varied from the intake opening to the discharge opening. For example, in certain embodiments, depending upon the chamber inserts used, the chamber depth at the intake opening may be from about 0.25 inches to about 4 inches. In certain embodiments where the rake insert 188 is attached to the interior surface 169, with or without the wear plate 170, or where only the wear plate 170 is attached to the interior surface 169, the chamber depth at the intake opening may be from about 3 inches to about 4 inches or from about 3.5 inches to about 4 inches. As shown in FIG. 14, for example, the chamber depth may decrease from the intake opening through the chamber 130 to a high point of the periphery of the rotatable tool 136. In this portion of the chamber 130, the gradual decrease in chamber depth can facilitate the cutting, grinding, mulching, and shredding of trees and other vegetation. In such embodiments, the rake tines 190 can create agitation such that material can be repeatedly forced into contact with the rotatable tool 136. Adjacent to the discharge opening, at the high point of the periphery of the rotatable tool 136, the chamber depth may be at its smallest. For example, the channel depth of an imaginary plane that, when in the first position, is perpendicular to ground and intersecting both the high point of the periphery of the rotatable tool 136 and the interior surface 169 of the housing 128 can be less than about 1 inch; and in certain embodiments, between about 0.9 and about 0.95 inches. From the a high point of the periphery of the rotatable tool 136 toward the discharge opening, the chamber depth may increase to eject a large amount of processed material over a wide area. For example, the chamber depth at the discharge opening may be from about 4.5 inches to about 7 inches; in certain embodiments, from about 5 inches to about 6 inches; and in certain embodiments, from about 5.25 inches to about 5.5 inches.

The chamber depth may vary based on whether a chamber insert is used, and if so, based on the type of chamber insert used. As a result, a chamber depth profile may vary between different chamber sections. In other embodiments, when the shear bar insert 76 is attached to the interior surface 69, with or without the wear plate 70, the chamber depth throughout most of the length or height of the chamber 30 may be similar to that described above for the embodiments including a rake insert 188 and/or a wear plate 170, with the exception of a portion adjacent the intake opening. For example, at the intake opening, the chamber depth may be much shorter at about 0.125 inches to about 1.5 inches; about 0.25 inches to about 0.5 inches; in certain embodiments, about 0.3 inches to about 0.4 inches; and in certain embodiments, about 0.375 inches (i.e., ⅜″). In such embodiments, the shear bar insert 76 can facilitate the reduction of material fed into the chamber 30, such that a material size can be so restricted whether the land preparation apparatus 14 may be moving in a standard, forward or reverse, back-dragging direction. In certain embodiments, performing one or two passes over a designated area with the land preparation apparatus 14 having the shear bar insert 76 may result in a finished product. Furthermore, the relatively larger chamber depth above the shear bar insert 76 may result in a pressure difference causing at least partial suction near the shear bar insert 76 and blowing in an area thereunder.

Regardless of the type of chamber insert employed, or whether a chamber insert is employed, exposed surfaces within the chamber may be vulnerable to a significant amount of wear. However, use of chamber inserts (e.g., 70) may allow for easy and efficient management of such wear on chamber surfaces. For example, the use of chamber inserts (e.g., 70) may allow for worn surfaces to be easily replaced. Moreover, the use of chamber inserts (e.g., 70) may allow for replacement of chamber surfaces to be limited to only those that require it. In certain embodiments, at least a substantial portion of the interior surface 69 may be covered by one or more chamber inserts (e.g., 70). For example, in embodiments where the interior surface 69 comprises multiple interior surface sections (e.g., 69a, 69b, and 69c), one or more chamber inserts (e.g., 70) may be releasably attached to one or more or all of the interior surface sections (e.g., 69a, 69b, and 69c).

Referring back to FIG. 5, for example, each of the three distinct interior surface sections 69a, 69b, and 69c has the wear plate 70 and the shear bar insert 76 releasably attached thereto and are defined by the such chamber inserts (e.g., 70, 76). As shown in FIG. 5, each of the chamber inserts (e.g., 70, 76) may comprise substantially the same width. Furthermore, each of the chamber inserts (e.g., 70, 76) may be interchangeable among the interior surface sections (e.g., 69a, 69b, and 69c). Interchangeability among the chamber inserts (e.g., 70, 76) can also allow for efficient and cost effective management of wear and tear on chamber surfaces. In particular, existing chamber inserts (e.g., 70, 76) can be easily rotated to different interior surface sections (e.g., 69a, 69b, and 69c) to better distribute the wear amongst such chamber inserts, especially where one or more chamber inserts is experiencing substantially more wear than other chamber inserts. Likewise, worn chamber inserts (e.g., 70, 76) can be easily replaced by new chamber inserts. While conventional land preparation apparatuses may require a large portion or an entirety of a chamber surface to be replaced when any portion has sufficient wear, the interchangeability of the present chamber inserts (e.g., 70, 76) and the inclusion of multiple interior surface sections (e.g., 69a, 69b, and 69c) can limit replacement to only those chamber inserts with sufficient wear. For example, the wear plate 70 in one interior surface section (e.g., 69a, 69b, and 69c) while the existing, corresponding shear bar insert 76, as well as wear plates in other interior surface sections, may be preserved.

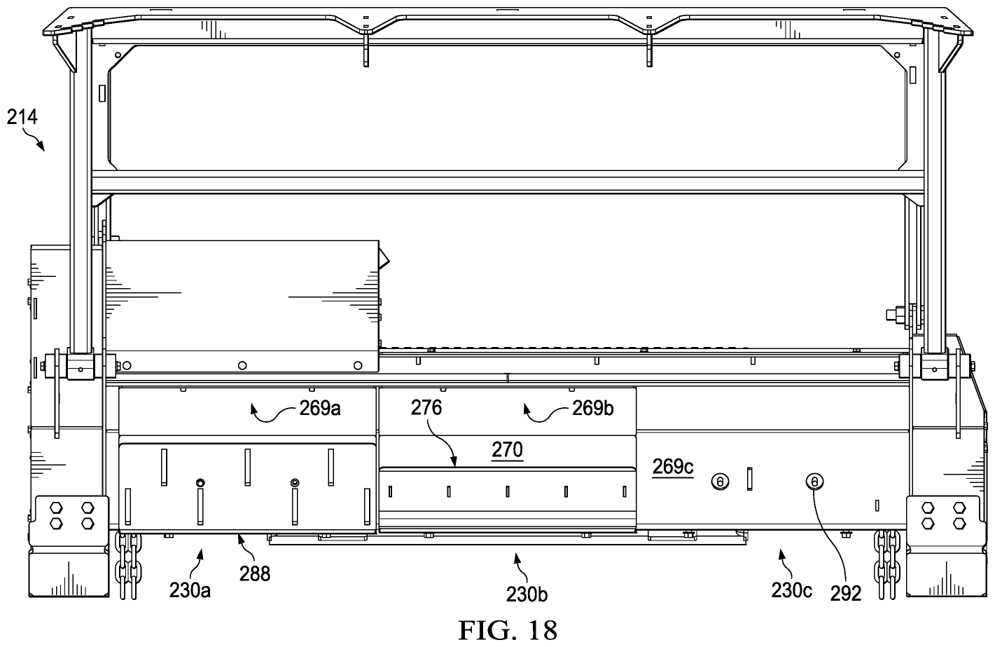

In addition to improving wear management, the interchangeability of the present chamber inserts (e.g., 70, 76) and the inclusion of multiple interior surface sections (e.g., 69a, 69b, and 69c) may also enhance the functionality of the land preparation apparatus 14. While FIG. 5 shows wear plates 70 and shear bar inserts 76 releasably attached to each of the three distinct interior surface sections 69a, 69b, and 69c, other configurations may be provided based on the needs of the task at hand, i.e., the type of processing and/or the material to be processed. For example, and as shown in FIG. 18, it may be desired that the first interior surface section 269a include the rake insert 288, that the second interior surface section 269b include the wear plate 270 and the shear bar insert 276, and that the third interior surface section 269c remain without a chamber insert. In such embodiments, different portions of the land preparation apparatus (e.g., 14) may be utilized based on the relative positioning of the chamber inserts provided therein. It will be appreciated that in other embodiments, a land preparation apparatus may include any suitable chamber inserts in any of a variety of suitable configurations.

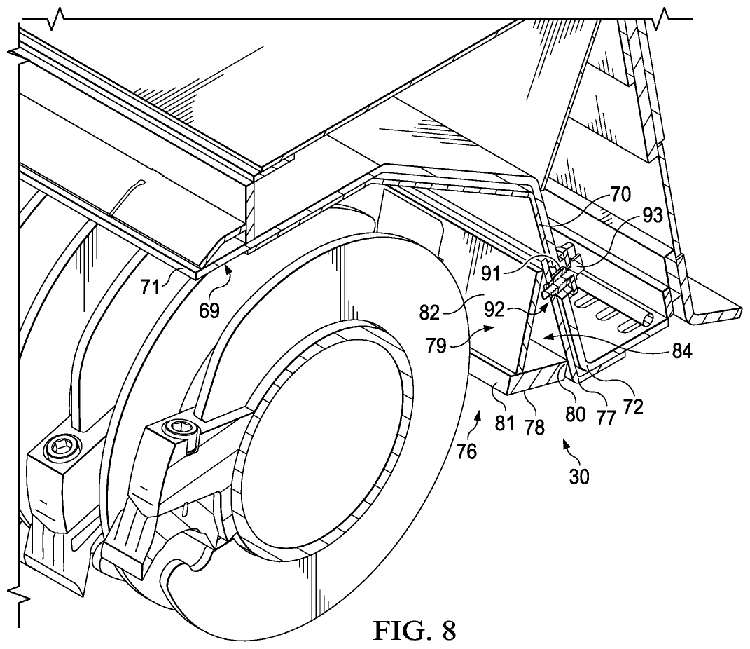

In certain embodiments, and referring back to FIGS. 8-10, 12, 13, 16, and 17, for example, the chamber inserts (e.g., 70, 76, 188) may be connected by welded threaded fasteners 91, 191 that are not exposed within the chamber 30. In order to accommodate such threaded fasteners, the interior surface 69 may define one of more chamber insert receiving holes 92. As shown in FIG. 8, for example, the chamber insert receiving hole 92 may receive the threaded fastener 91, such that the threaded fastener 91 is protected from exposure in the chamber 30. In certain embodiments, and as shown in FIG. 8, the threaded fastener 91 may be secured by a bolt 93 or any other suitable method. Protecting the threaded fasteners 91 from exposure in the chamber 30 is another way in which wear management can be improved with the present land preparation apparatus 14. In particular, ensuring the securement of the chamber inserts (e.g., 70, 76, 188) can help to extend a life of each insert and maintain the integrity of the fasteners 91, 191 for easy and efficient removal.

In certain embodiments, a number and relative positioning of the threaded fasteners 91 of each of the chamber inserts (e.g., 70, 76, 188) can be made uniform to further promote the interchangeability of the chamber inserts. For example, and as shown in FIGS. 9, 10, 12, 13, 16, and 17, each of the wear plate 70, the shear bar insert 76, and the rake insert 188 can include a pair of threaded fasteners 91, 191 on an inner surface thereof In such embodiments, the threaded fasteners 91, 191 of each pair can be spaced apart by substantially the same distance. Moreover, as shown in FIGS. 8 and 18, the interior surface 69, 269 may define one or more pairs of chamber insert receiving holes 92, 292, such that a number of chamber insert receiving holes 92, 292 is at least the number of fasteners (e.g., 91) to be received in the interior surface 69 and that the one or more pairs of chamber insert receiving holes 92, 292 may align with each pair of threaded fasteners (e.g., 91) of the one or more chamber inserts (e.g., 70, 76, 188). In such embodiments, each of the interior surface sections (e.g., 69a, 69b, and 69c) may define a same number of chamber insert receiving holes 92. For example, each interior surface section (e.g., 69a, 69b, and 69c) may define a pair of chamber insert receiving holes 92 near an upper edge 71 of the interior surface 69, to accommodate, for example, the wear plate 70, and a pair of chamber insert receiving holes 69 near a lower edge 72 of the interior surface 69, to accommodate, for example, the shear bar insert 76 or the rake insert 188.

As shown in FIGS. 6 and 14, for example, the rotatable tool 36, 136 may have exposure outside of the housing 28, 128. Such exposure can allow for greater control and flexibility when cutting, grinding, mulching, and shredding tress and other vegetation. In certain embodiments, the amount of exposure of the rotatable tool 36, 136 may be from about 1 inches to about 2 inches outward from the housing 2; in certain embodiments, from about 1.1 inches to about 1.5 inches; and in certain embodiments, about 1.25 inches. In certain embodiments, the housing 28, 128 and rotatable tool 36, 136 of the land preparation apparatus 14 may be configured to discharge material at an angle parallel to the ground surface, instead of, for example, at a lesser angle, toward the ground surface. As a result, the discharge angle can allow for discharge at a great distance and more efficient handling of already-processed material.

In certain embodiments, a kit can be provided. For example, the kit may be a replacement parts kit. The kit may include one or more chamber inserts. In certain embodiments, the kit may include two chamber inserts. In such embodiments, the kit may include the wear plate 70 and the shear bar insert 76. In other such embodiments, the kit may include the wear plate 70 and the rake insert 188. In certain embodiments, the kit may include a variety of types of chamber inserts as described herein, and in other embodiments, the kit may include multiple chamber inserts of a single type. It will be appreciated that a kit may include any of a variety of configurations of the chamber inserts described herein. In certain embodiments, the kit may further include one or more land preparation tools 52, such as those described herein. In certain embodiments, the kit may further include one or more tool holders 50.

In certain embodiments, a method of providing one or more chamber inserts can be provided. In certain embodiments, a method of protecting an interior surface (e.g., 69) of land preparation apparatus housing (e.g., 28) can include providing one or more chamber inserts (e.g., wear plate 70); installing the one or more chamber inserts (e.g., 70) on the interior surface 69 within a chamber (e.g., 30) of the housing 28; and securing the one or more chamber inserts (e.g., 70) to the housing 28. In certain embodiments, a method of replacing a chamber insert on a land preparation can include providing one or more replacement chamber inserts (e.g., wear plate 70); removing one or more previously connected chamber inserts from a housing (e.g., 28); installing the one or more replacement chamber inserts (e.g., 70) on an interior surface (e.g., 69) within a chamber (e.g., 30) of the housing 28; and securing the one or more replacement chamber inserts (e.g., 70) to the housing 28.

It is noted that terms like “specifically,” “preferably,” “commonly,” and “typically” are not utilized herein to limit the scope of the claimed invention or to imply that certain features are critical, essential, or even important to the structure or function of the claimed invention. Rather, these terms are merely intended to highlight alternative or additional features that may or may not be utilized in a particular embodiment of the present invention. It is also noted that terms like “substantially” and “about” are utilized herein to represent the inherent degree of uncertainty that may be attributed to any quantitative comparison, value, measurement, or other representation.

Having described in detail and by reference to specific embodiments thereof, it will be apparent that modifications and variations are possible without departing from the scope of the invention defined in the appended claims. More specifically, although some aspects of the present invention are identified herein as preferred or particularly advantageous, it is contemplated that the present invention is not necessarily limited to these preferred aspects of the invention.

All documents cited in the Detailed Description are, in relevant part, incorporated herein by reference; the citation of any document is not to be construed as an admission that it is prior art with respect to the present invention. To the extent that any meaning or definition of a term in this written document conflicts with any meaning or definition of the term in a document incorporated by reference, the meaning or definition assigned to the term in this written document shall govern.

While particular embodiments have been illustrated and described, it would be obvious to those skilled in the art that various other changes and modifications can be made without departing from the spirit and scope of the invention. It is therefore intended to cover in the appended claims all such changes and modifications that are within the scope of this invention.

1. A land preparation apparatus comprising:
a rotatable tool having a longitudinal axis and comprising a body and a plurality of tool assemblies, wherein the plurality of tool assemblies are disposed on an outer surface of the body;
a housing comprising:
a first end at a first side of the housing;
a second end at a second side of the housing, wherein the rotatable tool is rotatably connected to the first end and the second end; and
a framework extending between and connected to each of the first end and the second end, the framework having an interior surface that extends along at least a portion of the width of the rotatable tool and, along with at least a portion of a periphery of the rotatable tool, the first end, and the second end, defines a chamber, the interior surface of the chamber having an upper edge and a lower edge; and
wherein the interior surface comprises two or more interior surface sections across a width of the interior surface, and wherein each of the interior surface sections defines a corresponding chamber section.

2. The land preparation apparatus according to claim 1, wherein
the interior surface comprises a first interior surface section and a second interior surface section, and wherein the first interior surface section and the second interior surface section define a first chamber section and a second chamber section, respectively.

3. The land preparation apparatus according to claim 2, wherein
the interior surface further comprises a third interior surface section, and wherein the third interior surface defines a third chamber section.

4. The land preparation apparatus according to claim 3, wherein
the interior surface further comprises a fourth interior surface section, and wherein the fourth interior surface defines a fourth chamber section.

5. The land preparation apparatus according to claim 1, further comprising
one or more chamber inserts releasably attached to the interior surface, wherein at least a portion of each of the one or more chamber inserts resides in the chamber.

6. The land preparation apparatus according to claim 5, wherein
the one or more chamber inserts define the two or more interior surface sections.

7. The land preparation apparatus according to claim 5, wherein
at least one of the one or more chamber inserts is releasably attached to each of the two or more interior surface sections.

8. The land preparation apparatus according to claim 5, wherein
the one or more chamber inserts are interchangeable among the two or more interior surface sections.

9. The land preparation apparatus according to claim 5, wherein
the one or more chamber inserts comprise:
a wear plate releasably attached to the interior surface of the housing, the wear plate having an inner surface and an outer surface and extending along a width of one of the two or more interior surface sections, the inner surface of the wear plate being in contact with the interior surface of the housing; and
a shear bar insert releasably attached to the wear plate, the shear bar insert having a shear bar base plate with an inner surface and extending along at least a portion of a width of the wear plate, the inner surface of the shear bar base plate facing the interior surface of the housing, being in contact with the wear plate.

10. The land preparation apparatus according to claim 9, wherein
each of the two or more interior surface sections has a wear plate and shear bar insert releasably attached thereto.

11. The land preparation apparatus according to claim 5, wherein
each of the two or more interior surface sections defines one or more chamber insert receiving holes.

12. The land preparation apparatus according to claim 11, wherein
each of the two or more interior surface sections defines the same number of chamber insert receiving holes.

13. The land preparation apparatus according to claim 11, wherein
each of the one or more chamber inserts comprises one or more threaded fasteners, wherein the one or more threaded fasteners are received by the one or more chamber insert receiving holes, such that the one or more threaded fasteners are protected from exposure in the chamber.

14. The land preparation apparatus according to claim 1, wherein
each of the two or more interior surface sections comprises substantially the same width.

15. A land preparation apparatus comprising:
a rotatable tool having a longitudinal axis and comprising a rotatable drum and a plurality of tool assemblies, wherein the plurality of tool assemblies are disposed on an outer surface of the rotatable drum;
a housing comprising:
a first end cap at a first side of the housing;
a second end cap at a second side of the housing, wherein the rotatable tool is rotatably connected to the first end cap at a first end and the second end cap at a second end; and
a framework extending between and connected to each of the first end cap and the second end cap, the framework having an interior surface that extends along at least a portion of the width of the rotatable tool and, along with at least a portion of a periphery of the rotatable tool, the first end cap, and the second end cap, defines a chamber, the interior surface of the chamber having an upper edge and a lower edge; and
one or more chamber inserts releasably attached to the interior surface, wherein at least a portion of each of the one or more chamber inserts resides in the chamber;
wherein the interior surface comprises a first interior surface section, a second interior surface section, and a third interior surface section across a width of the interior surface, the one or more chamber inserts defining the first interior surface section, the second interior surface section, and the third interior surface;
wherein the first interior surface section, the second interior surface section, and the third interior surface section define a first chamber section, a second chamber section, and a third chamber section, respectively;
wherein the first interior surface section, the second interior surface section, and the third interior surface section comprise substantially the same width; and
wherein the one or more chamber inserts are interchangeable among the first interior surface section, the second interior surface section, and the third interior surface section.

16. A land preparation apparatus comprising:
a rotatable tool having a longitudinal axis and comprising a body and a plurality of tool assemblies, wherein the plurality of tool assemblies are disposed on an outer surface of the body;
a housing comprising:
a first end at a first side of the housing;
a second end at a second side of the housing, wherein the rotatable tool is rotatably connected to the first end and the second end; and
a framework extending between and connected to each of the first end and the second end, the framework having an interior surface that extends along at least a portion of the width of the rotatable tool and, along with at least a portion of a periphery of the rotatable tool, the first end, and the second end, defines a chamber, the interior surface of the chamber having an upper edge and a lower edge and defining one or more chamber insert receiving holes; and
one or more chamber inserts releasably attached to the interior surface, each of the one or more chamber inserts comprising one or more threaded fasteners, wherein the one or more threaded fasteners are received by the one or more chamber insert receiving holes, such that the one or more threaded fasteners are protected from exposure in the chamber, and wherein at least a portion of each of the one or more chamber inserts resides in the chamber.

17. The land preparation apparatus according to claim 16, wherein
each of one or more chamber inserts comprises the same number of threaded fasteners.

18. The land preparation apparatus according to claim 17, wherein
each of the one or more chamber inserts comprises a pair of threaded fasteners on an inner surface, wherein the threaded fasteners of each pair of threaded fasteners are spaced apart by substantially the same distance.

19. The land preparation apparatus according to claim 18, wherein
the interior surface defines one or more pairs of chamber insert receiving holes, wherein the one or more pairs of chamber insert receiving holes align with each pair of threaded fasteners of the one or more chamber inserts.

20. The land preparation apparatus according to claim 19, wherein
the interior surface defines one or more pairs of chamber insert receiving holes near an upper edge of the interior surface and one or more pairs of chamber insert receiving holes hear a lower edge of the interior surface.
